(19) United States
(12) Patent Application Publication
(10) Pub. No.: US 2008/0111969 A1
(43) Pub. Date: May 15, 2008

(54) Automated Cutting of Optical Lenses

(76) Inventors: Ricardo Covarrubias, Guadalajara (MX); Dominique E. Merz, Long Beach, CA (US); John D. Buchara, La Mesa, CA (US)

Correspondence Address: CHARMASSON, BUCHACA & LEACH, LLP, 1545 HOTEL CIRCLE SOUTH, SUITE 150, SAN DIEGO, CA, 92108-3426, US

(21) Appl. No.: 11/632,487

(22) PCT Filed: Jul. 13, 2005
(86) PCT No.: PCT/US05/24663

§ 371 Date: Jan. 12, 2007

Related U.S. Application Data
(63) Continuation of application No. 10/889,798, filed on Jul. 13, 2004, now abandoned.

(51) Int. Cl. B23K 26/36; G02C 13/00

(52) U.S. Cl. 351/178; 219/386; 219/68; 451/43; 451/5; 83/53

(57) ABSTRACT

A laser engraving device is adapted to process a plurality of lens blanks in a single processing run. The lens blanks are cut or edged serially where the laser cutter path for each blank is calculated by software which interprets lens blank optical parameters, prescription parameters and frame trace parameters, all of which can vary for each blank being edged. Minor adjustment of the angle of incidence between the laser cutter (20) and the target blank (23) is accomplished by a tiltable blank holder (24). More aesthetically appealing “rimless” lens are achieved by cutting the lens to have a frame-shaped edge from a single monolithic piece of blank material. Such shaping of the edge portion provides more ornamentation options on “rimless” eyeglasses. The manipulation of laser power, velocity, and number of passes over given position on the lens results in cutting depth variability which can be selected to further ornament the edge region and allow for the carrying of dyes or tints to a greater degree than an untreated or polished lens surface.

### FIELD OF THE INVENTION

This invention relates to the manufacture of optical lenses and more particularly to the cutting, edging and otherwise finishing of eyeglass lenses from lens blanks.

### BACKGROUND

The manufacture of eyeglass lenses is a time-consuming, multi-step process which generally includes the measuring of a patient's condition to derive a prescription for each eye, the measuring or tracing of the size and shape of the desired eyeglass frame, the selection of a lens blank for each eye which will accommodate the prescription for that eye and the frame, measuring or otherwise determining the optical parameters of each blank such as its power, and for cylindrical lenses, its optical axis orientation, and blocking or otherwise properly orienting each lens blank according to its optical parameters and the prescription parameters in a machine or number of machines which can further process the blank into the final lens. Such processing can include a grinding step to shape the front and back surfaces of the lens, polishing the surfaces, edging or cutting away material from the lens blank so that the finished lens may fit the selected eyeglass frame, beveling or grooving the peripheral edge to snugly fit the frame, drilling attachment holes for temples or earpieces and nose bridges for so-called “rimless” eyeglasses, and tinting the lenses for sunglasses.

In general, most eyeglass lenses fall into two categories, namely spherical lenses and cylindrical lenses, each being suited to correct different patient conditions. Referring now to FIGS. 1 and 2, a spherical lens blank 1 is typically shaped to have a convex front surface 2, a concave rear surface 3, and a circular perimeter 4 having a lower edge 5 which lies substantially within a plane 6 substantially perpendicular to a central axis 7 which can be spaced apart a distance R_{OC} from the optical center 8 in spherical lens blanks having a decentration of greater than zero. Each spherical lens blank is sized to be about 7.5 centimeters (3 inches) in diameter and has a thickness contour which allows it to serve as the lens stock for a wide variety of eyeglass frames. Referring now to FIG. 3, cylindrical lenses differ from spherical lenses in that the curvature of its surfaces can change according to meridian or angular direction from the central axis 10. As such, the lower edge 11 may have a saddle shape. The meridian or direction of least curvature can be defined as the cylindrical or optical axis 12 of a cylindrical lens.

Each lens blank, whether spherical or cylindrical in type is characterized by its lens blank parameters which can include the material from which the blank is made such as acrylic and polycarbonate plastic materials, and the optical parameters which define the shape contour of the front and rear surfaces, which can include its diopter values, decentration of the optical center and cylindrical axis orientation. Even non-prescription lens blanks can be said to have such parameters though they may have zero values such as zero optical power values. The parameters which describe the lens blank are collectively referred to as “lens blank parameters”. A difference in even one parameter may result in a different type of lens blank. Such lens blanks are commercially available from a number of sources such as the Sola Lens company of Pensacola, Fla., or the Younger Optical company of Torrance, Calif. Depending on the prescription, a “stock” lens blank may have to be “customized” or further ground and polished to provide the desired front and back surface shapes. It has been found that most prescriptions can be filled by commercially available finished lens blanks without further grinding and polishing of the optical surfaces.

Referring back to FIGS. 1 and 2, the lens blank 1 is then “edged” or cut along a path 12 whose shape is generally defined by the shape of the selected frame. Eyeglass frames come in numerous shapes, primarily dictated by fashion. The translational and rotational position of the path on the lens blank is determined by the lens blank parameters and the eventual user's prescription. As disclosed in Kennedy U.S. Pat. No. 5,462,475, incorporated herein by this reference, accounting for the lens blank parameters generally requires the so-called “blocking” or holding of the lens blank in a specific orientation so that proper “edging” can occur. This is a time-consuming process which requires special skill by the operator who will typically use a lensometer to determine the lens blank parameters, temporarily mark the blank with one or more ink dots to represent the location and or orientation of those parameters, and precisely attaching a temporary blocking or holding structure in accordance with the markings. Attempts have been made to further automate the edging process by providing machines known as “self-blocking” devices which analyze a blank to determine its optical parameters, and “block” the blank automatically. Such devices tend to be expensive and handle lenses individually.

So called “rimless” eyeglasses have recently gained popularity. Rimless eyeglasses are typically formed by drilling through-holes in the peripheral edge portions of each of the edged lenses to facilitate the fastening of nose bridge and temple or earpiece structures thereon. A significant advantage of “rimless” lenses is that they do not require quite as accurate edging in order to adequately fit a given frame. However, because of the absence of the structurally stiffening and strengthening surrounding frame, many “rimless” designs can have a greater susceptibility to damage than their “rimmed” counterparts. Another disadvantage is that the mechanical drilling of the through-holes can cause stress damage to the lenses.

Another disadvantage of “rimless” eyeglasses is that they typically do not offer the same potential for frame ornamentation that “rimmed” eyeglasses do.

Lasers and abrasive water jet-type cutting devices have been used in the past to machine manufactured parts made from a number of different materials such as metal and plastic. Laser and abrasive jet machining typically requires time consuming programming for each part shape being made. Further, use of lasers and abrasive jets can induce heat and residual artifacts which can damage parts or require further machining.

Therefore, there is a need for the more automated and economical edging of eyeglass and sunglass lenses which address some or all of the above described disadvantages.

### SUMMARY

The instant embodiments provide a device and method for at least partially manufacturing eyeglass and sunglass lenses.

In some embodiments there is a flatbed translational laser or abrasive water jet engraving device or cutter adapted to process a plurality of lens blanks. The lens blanks are etched serially in a single automated processing run where the path for the cutter for each blank is calculated by software which interprets lens blank parameters, prescription parameters (if any) and frame parameters for each lens blank.

Other embodiments provide for minor adjustment of the angle of incidence between the cutter and the target blank. Other embodiments provide for a “rimless” lens having a frame-shaped edge cut from a single monolithic piece of blank or feedstock material. Such shaping of the edge portion provides more ornamentation options on “rimless” eyeglasses. The manipulation of laser or abrasive jet power, velocity, and number of passes over given position on the lens results in cutting depth variability which can be selected to further ornament the edge region and allow for microtexturing to enhance the carrying of dyes or tints.

Other embodiments provide a plurality of action heads such as the laser or abrasive jet cutter, ink jet nozzles, gas dryer nozzles, or curing or heating lamps. Other embodiments provide a conveyor based system having a number of stations for cutting, engraving, and coloring of lenses. Other embodiments provide a number lens blank carrier beds each particularly adapted to laser cutting, or abrasive water jet cutting, and further processing of framed lenses.

In some embodiments there is provided a device for forming a plurality of eyeglass lenses in a single automated processing run from a plurality of lens blanks, said device comprises a holder sized and shaped to carry said blanks, a cutter tool, and a microprocessor adapted to control a location of said cutting tool with respect to said holder according to a frame parameters data set, a lens blank parameters data set and a prescription parameters data set. In other embodiments said frame parameters data set comprises data representing a plurality of frame shapes. In other embodiments said lens blank parameters data set comprises data representing a plurality of lens blank types. In other embodiments said prescription parameters data set comprises data representing a plurality of prescriptions. In other embodiments said holder means for temporarily securing said blanks thereon. In other embodiments said holder comprises holder portions for contacting said blanks. In other embodiments said holder comprises sticky surfaces for contacting said blanks. In other embodiments said holder comprises a plurality of holder portions wherein each of said holder portions is associated with a unique location identifier. In other embodiments said lens blanks parameters data set comprises lens blank parameters for each of said blanks. In other embodiments said frames parameters data set comprises an ornamental structure definition section. In other embodiments there is an angle of incidence between said cutter tool and said holder which is adjustable. In other embodiments said device further comprises said cutter tool being mounted to an angularly adjustable carriage. In other embodiments said device further comprises said holder being mounted to a gimbal. In other embodiments said device further comprises a part of said holder being mounted upon a jack. In other embodiments said angle of incidence is adjustable between a range of about 0 degrees and 12 degrees from vertical. In other embodiments said device further comprises a blocking structure for each of said holding portions.

In other embodiments the blocking structure comprises: a rigid body; an arcuate pad portion adapted to contact a lens blank surface; and means for temporarily bonding said blocking structure to one of said holding portions. In other embodiments arcuate pad portion comprises a sticky surface. In other embodiments said means for temporarily bonding comprise a magnet. In other embodiments said blocking structure further comprises magnetic means for temporarily securing said pad portion to said body.

In yet other embodiments the microprocessor is further adapted to control an operational strength of said cutter to control a cutting depth of said cutter. In other embodiments said cutter is selected from the group consisting of laser cutters, water jet cutters, and abrasive water jet cutters. In other embodiments said device further comprises each of said blanks being marked with an angular orientation indicia. In other embodiments said device further comprises means for cutting nose-bridge and temple attachment through-holes in said blanks.

Other embodiments provide for an eyeglass lens comprising: an optical portion; a peripheral portion at least partially surrounding said optical portion; wherein said peripheral portion comprises an ornamentation region. In other embodiments said ornamentation region is sized and shaped to form a frame structure.

In yet other embodiments said ornamentation region comprises: a cross-section comprising a first zone having a first cross-sectional width, a second zone having a second cross-sectional width, and a third zone having a third cross-sectional width; wherein said second zone separates said first and third zones; and, wherein said second cross-sectional width is greater than said first cross-sectional width, and said second cross-sectional width is greater than said third cross-sectional width. In other embodiments said ornamentation region comprises a micro-textured surface. In other embodiments said microtextured surface carries a tinting substance. In other embodiments said ornamentation region is sized and shaped to form a frame structure. In other embodiments said ornamentation region is shaped to form an ornamental serpentine structure. In other embodiments said holder comprises an amount of hand formable material. In other embodiments said amount is selected from the group consisting of modeling clay and sculpting dough. In other embodiments said device further comprises a precision optical analyzer tool for detecting a subset of said lens blank parameters. In other embodiments said device further comprises an ink dispensing tool. In other embodiments said ink dispensing tool and said cutting tool are mounted to a single translatable carriage. In other embodiments the device further comprises a movable guard structure for covering a portion of said carriage during operation of said cutter tool. In other embodiments the device further comprises a curing lamp. In other embodiments said guard is movable between a retracted and extended position. In other embodiments said guard covers an emitter of said ink dispenser tool while said guard is in said extended position. In other embodiments said microprocessor is further adapted to control a location of said ink dispensing tool. In other embodiments said microprocessor is further adapted to control a position of said guard. In other embodiments said cutter tool is mounted within a first cutting station and said ink dispensing tool is mounted within a second inking station. In other embodiments said inking station further comprises a lens parameter detector. In yet other embodiments said device further comprises a mechanism for moving said holder between said first and second stations. In other embodiments said mechanism comprises a robotic arm and a conveyor system. In other embodiments said holder comprises a baseplate for carrying a plurality of blocking structures. In other embodiments each of said blocking structures comprises a body portion dimensioned to carry a first one of said lens blanks a first distance from said baseplate. In other embodiments said holder further comprises a disposable bib shaped and dimensioned to cover a portion of an upper surface of said baseplate proximate to and surrounding said blocking structure. In other embodiments said holder further comprises an apertured cover having surfaces for contacting said blanks. In other embodiments said cover is hingedly mounted to said holder. In other embodiments said surfaces comprise a durable resiliently flexible material. In other embodiments said material is neoprene rubber.

In yet other embodiments the lens blank holder comprises a structure comprising: an apertured baseplate having baseplate surfaces for contacting said blanks; and, an apertured cover having cover surfaces for contacting said blanks. In other embodiments said surfaces comprise a durable resiliently flexible material. In other embodiments said material is neoprene rubber. In other embodiments said cover is hingedly mounted to said holder. In other embodiments said holder further comprises a net mounted below said apertured baseplate, said net being shaped and dimensioned to capture a lens cut from one of said blanks.

In another embodiment there is provided a device for edging an eyeglass lens from a lens blank, said device comprises: a holder sized and shaped to carry said blank; a cutter tool; and, a microprocessor adapted to control a location of said cutter tool with respect to said holder according to a frame parameters data set, a lens blank parameters data set and a prescription parameters data set.

Yet further embodiments provide for a method for forming an eyeglass lens from a lens blank, said method comprises: placing said blank into a holder; accessing a frame parameter data set, and a lens blank parameter data set; calculating a cutting path from said data sets; and, edging said blank according to said path using a cutting beam. In other embodiments, the method further comprises: determining an optical angular orientation parameter of said blank; wherein said placing occurs according to said orientation parameter; and, wherein said accessing comprises accessing a prescription data set. In other embodiments the method further comprises drilling nosebridge and earpiece attachment holes prior to said edging step. In other embodiments said cutting path is serpentine. In other embodiments the method further comprises leaving bridges along said path. In other embodiments the method further comprises running a cutter repeatedly along said path thereby providing a smoothened edge. In other embodiments said edging comprises forming a frame structure from said blank. In other embodiments the method further comprises dispensing an amount of ink onto a surface of said blank to create a colored region. In other embodiments the method further comprises pretreating a surface of said blank with a coloring pretreatment to enhance a permanence of said colored region. In other embodiments said etching comprises forming a microtextured surface from said blank. In other embodiments the method further comprises coloring said microtextured surface. In other embodiments the method further comprises accessing a database containing one or more of said data sets. In other embodiments said etching comprises automatically adjusting a strength setting of a cutting tool. In other embodiments said etching comprises adjusting a duration of a cutting tool operating on a portion of said blank to result in a trench. In other embodiments said etching comprises adjusting a cutting depth of a cutting tool.

Yet further embodiments provide for a method of coloring a frame structure on an eyeglass lens comprises: placing said structure into a holder; accessing an ornamental definition data set; dispensing an amount of ink onto a portion of said structure according to said ornamental definition data set. In other embodiments the method further comprises pretreating said portion to more readily carry said amount of ink. In other embodiments said pretreating comprises forming a microtextured surface on said portion. In other embodiments said pretreating comprises dispensing an amount of ink carrying substance on said portion. In other embodiments the method further comprises dispensing a sealer substance onto said amount of ink. In other embodiments the method further comprises curing said ink amount after said dispensing of said ink. In other embodiments the method further comprises second dispensing of a second amount of ink onto a second portion of said structure after said curing thereby creating a semipermanent colored portion and a temporary colored portion. In other embodiments said temporary colored portion is an optical parameter indicator dot.

### BRIEF DESCRIPTION OF THE DRAWING

FIG. 1 is a prior art top plan view of a lens blank.

FIG. 2 is a prior art cross-sectional side view of the blank of FIG. 1 taken along 2-2.

FIG. 3 is a prior art diagrammatic perspective view of a cylindrical lens blank.

FIG. 4 is a diagrammatic perspective view of a lens blank edging device according to the invention.

FIG. 5 is a diagrammatic partial perspective view of the device of FIG. 4.

FIG. 6 is a functional block diagram of the laser cutter control system.

FIG. 7 is a diagrammatic perspective view of a blank receiving multiple cutting laps.

FIG. 8 is a diagrammatic partial cross-sectional side view of a tiltable blank holder.

FIG. 9 is diagrammatic perspective view of an alternate tiltable blank holder.

FIG. 10 is a diagrammatic partial cross-sectional side view of an alternate tiltable blank holder.

FIG. 11 is a diagrammatic perspective view of a lens according to the invention cut to have a peripheral region shaped to form a partial frame.

FIG. 12 diagrammatic cross-sectional side view of the lens of FIG. 11 taken along line 12-12.

FIG. 13 diagrammatic enlarged partial cross-sectional side view of the lens of FIG. 12 taken in box 13-13.

FIG. 14 is a diagrammatic enlarged partial cross-sectional side view of a lens showing a mimicked wire frame ornamentation.

FIG. 15 is a diagrammatic enlarged partial cross-sectional side view of a lens showing a mimicked frame ornamentation on the inside, posterior or concave surface.

FIG. 16 is a diagrammatic perspective view of a lens according to the invention cut to have a stylized, ornamented peripheral region.

FIG. 17 diagrammatic enlarged partial cross-sectional side view of the lens of FIG. 16 taken along line 17-17 showing microtexturing.

FIG. 18 is a diagrammatic partial cross-sectional side view of a blank holder according to the invention.

FIGS. 19-21 are a generalized functional flow chart diagram of the laser cutter control software according to the invention.

FIG. 22 is a diagrammatic perspective view of a translatable carriage for carrying multiple action heads such as cutting tools, ink dispensers and curing lamps.

FIG. 23 is a functional block diagram of a multistationed processing system according to the invention.

FIG. 24 is a diagrammatic perspective view of a cutting station adapted to automatedly load a multiple lens blank holder.

FIG. 25 is a diagrammatic partial cross-sectional side view of a blank holder adapted for abrasive jet cutting.

FIG. 26 is a diagrammatic partial cross-sectional side view of an alternate embodiment of a blank holder adapted for abrasive jet cutting.

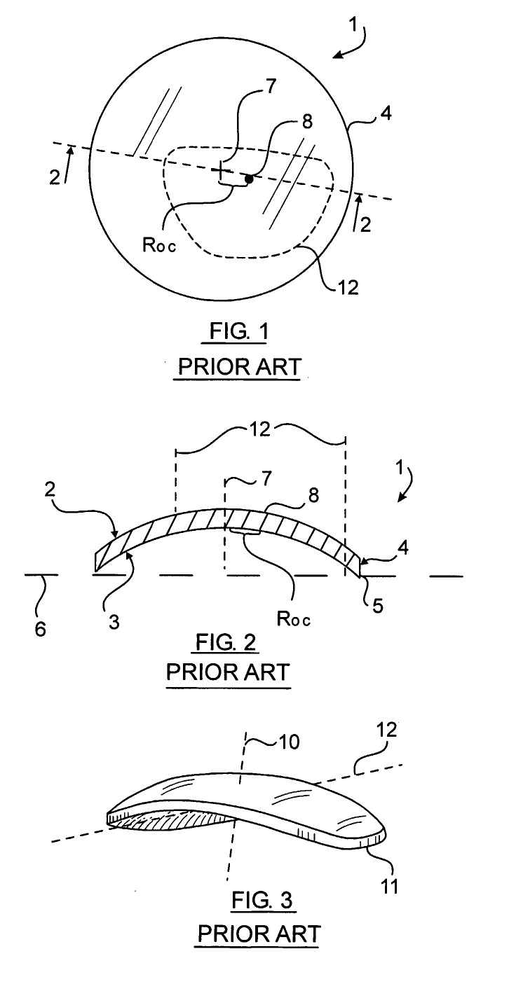

### DESCRIPTION OF THE PREFERRED EMBODIMENTS

The first embodiments are described with reference to a laser-based cutting device. Those skilled in the art will readily appreciate adaptation of these and other embodiments to other beam-type cutting devices such as water jet and abrasive water jet cutters.

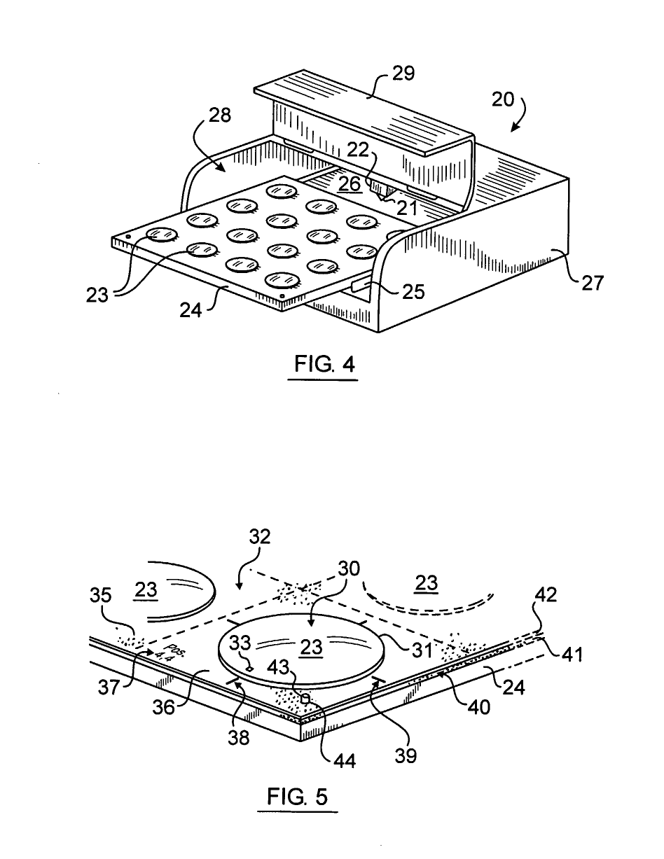

Referring now to the drawings, there is shown in FIG. 4 a laser-based optical lens blank edging device 20 having a horizontally translatable cutting laser 21 mounted upon an XY movable carriage 22 and oriented to emit a cutting beam for edging a plurality of lens blanks 23 temporarily secured upon a holder or bed 24 slidingly mounted to a drawer mechanism 25 for extraction from the internal cavity 26 of the device housing 27 through an opening 28 which is closed by a hinged lid 29 during operation. The device can be adapted from existing flatbed-style laser engravers such as disclosed in Garnier et al. U.S. Pat. No. 4,985,780 incorporated herein by this reference. A preferred laser engraver is the VENUS 35 brand engraver, commercially available from GCC USA company of Walnut, Calif.

Referring now to FIG. 5, there is shown a right/front corner portion of the bed 24 carrying a plurality of lens blanks 23. Each lens blank 23 is generally domed shape having a convex upper surface 30 and a concave lower surface, and a generally circular or shallow saddle shaped perimeter 31 depending on whether the blank is a spherical or cylindrical type lens respectively. This shape allows the lens blank to be placed in a “convex-surface-up” orientation where the perimeter rests against the substantially planar upper surface 32 of the bed. Each lens blank has been previously ground, polished, or otherwise manufactured to have certain lens blank parameters. Prior to edging, the lens blank is placed in one of an array of positions 35,36 on the upper surface of the bed 24. Each position is identified by a specific label 37, for example, “Pos. 4,4” as an indicated grid position and corresponding to a record or records in a data set or data sets containing lens blank, prescription, and frame parameters. In this example, there are 16 positions arranged in a 4×4 array on the bed. Those skilled in the art will readily appreciate other sizes and arrangements of positions. Alternately, each grid position can be in the form of crosshairs. For spherical blanks, the optical center of the blank is placed on the crosshair intersection. For cylindrical blanks, the optical axis is aligned with one of the crosshairs.

The lens blank is placed within target indicators 38,39 printed on the upper surface. For spherical blanks having no decentration, mere translational precision is required. For spherical lens blanks with decentration and cylindrical lens blanks, each blank preferably carries a permanent marking 33 indicating the angular direction of decentration and/or optical axis orientation, or merely a zero angle from which the location of the optical center and optical axis can be calculated from its associated lens blank parameters. This marking is placed in alignment with a selected target indicator to angularly orient the blank. In this embodiment, the operator is told to place the blank so that the indicia 33 lines up with the bottom target indicator 38. Alternately, blanks can be analyzed in a lensometer and marked accordingly with temporary ink markings, and the operator told to align the markings with one or more of the targeting indicators.

Each lens blank is preferably held in place upon a sheet-like replaceable carrying mat 40 having a semi-rigid base layer 41 made from cardboard or other semirigid, inexpensive, disposable material, and an upper sticky layer 42 to impede unwanted dislodgment of the lens blank from its position atop the mat. The mat upper surfaces are further imprinted to indicate the grid positions and act as the upper surface 32 of the bed. Precise placement of the mat upon the bed is facilitated by at least one alignment prominence or pin 43 for penetrating through an alignment hole 44 in the mat.

Referring now to FIG. 6, the edging of the lens blank in each position is accomplished by the precise control of the movement of a beam-type cutting device 50 such as a laser of abrasive water jet cutter along a locus or path on the surface of the lens blank. This path is calculated in a software program running on a microprocessor 51 which, in turn, controls the movement of the laser cutter with respect to the blanks including its X-Y coordinates over time and preferably the operational strength of the cutter tool such as the operational output power of a laser or the operational pressure of an abrasive water jet. Although in the preferred embodiment the laser cutter moves on its carriage, those skilled in the art will readily appreciate that the device may be adapted to keep the laser stationary and the bed moved. The software program accesses and interprets data sets containing the various parameters which will determine the eventual path and path depth for each grid position. There is preferably a data set of frame parameters 52 derived from a database generated by a tracer, CAD system or other source, and generally dictates the overall shape the completed lens must have in order to properly mount within the chosen eyeglass frame along with any ornamentation structures. There can be frame parameters for each position in an M by N array of blanks, where M and N are positive integers. There is a lens blank parameters data set 53 including, lens type, lens shape, thickness and material type, and if applicable, optical center coordinates, optical axis orientation, decentration amount, diopter values, spherical and cylindrical power values and any other parameter which helps to characterize the lens blank. A data set 54 of parameters defining the particular prescription of the end user for each lens blank is also accessed and processed by the program. These can include preferred final lens shape needs, pupil distance and lens angle parameters. It is important to note that these parameters as can be specific for each position in the grid on the bed.

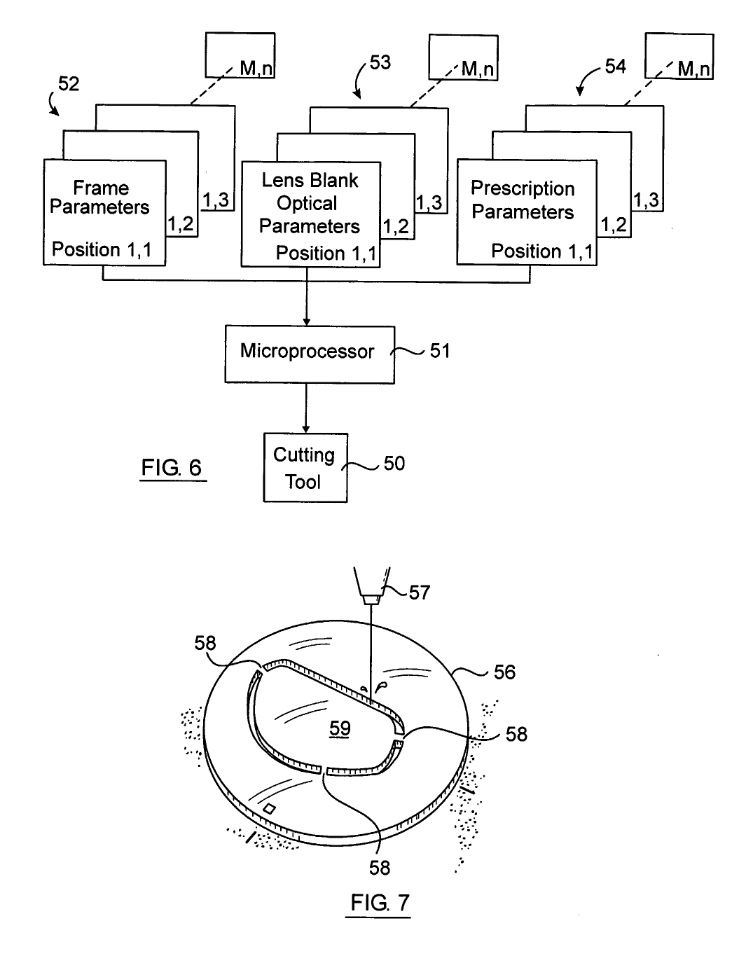

For some lens materials and laser powers, the edge of the lens after cutting may have a rough surface. This condition can be reduced by further processing. For example, for lens blanks placed on the mat in the concave-surface-up orientation, the system can automatically run two or more passes or laps of the laser over the target blank, thereby smoothing out the edge. Referring now to FIG. 7, for a blank 56 placed in the convex-surface-up orientation, running a complete lap along the entire path will typically cause the edged lens to drop away below the remainder of the blank in an unpredictable way preventing further precise cutting. In this orientation however, the system can run the laser 57 a number of incomplete laps leaving one or more “bridges” 58 which secure the optical portion 59 of the lens in a known location to the remainder of the blank for as long as possible. The bridges can be located in the most functionally or aesthetically inconsequential areas such as proximate to the temples or nose bridge connection points for rimless eyeglasses. The last cutting step would then be cutting through the bridge or bridges.

Alternately, after a processing run, the entire bed can be removed from the cutting device and placed in a separate ultraviolet oven which can treat the edge roughness to be easily removed during a final buffing step. Alternately, the carriage of the cutting device can be further adapted to carry an ultraviolet emitter or other targeted device which can be aimed to decrease roughness or otherwise treat the lens so that the roughness can be more easily removed.

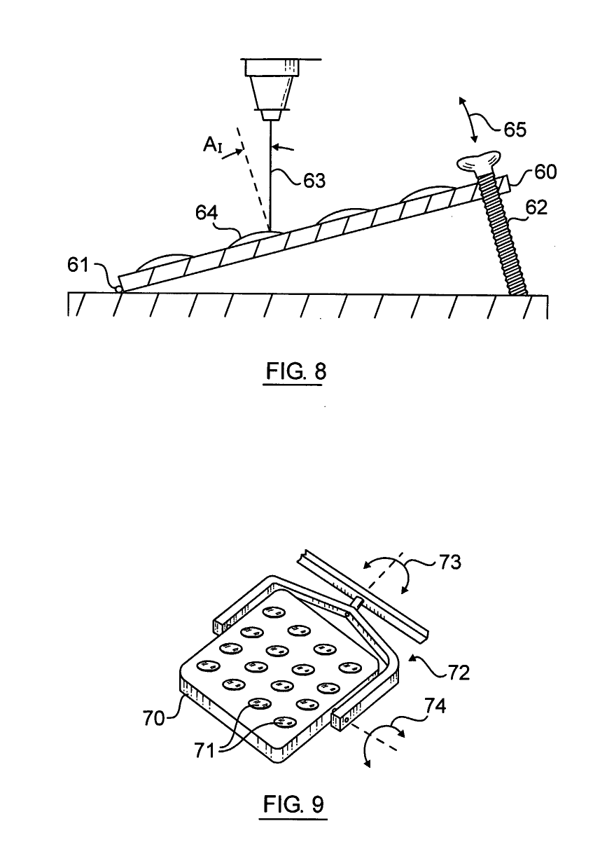

Referring now to FIG. 8, there is shown an alternate embodiment of the bed 60 which allows for the angular tilting of the bed surface to allow angled cutting of the lens blanks, particularly for the purpose of cutting mounting holes in “rimless” eyeglasses. As previously described, lenses intended for “rimless” eyeglasses often require the cutting of holes for the attachment of nose bridge supports and temples or earpiece supports. Many designs require that the holes be oriented so that they are substantially normal to the surface of the lens. As such, the holes are often required to be formed at an angle off the central axis of the blank which is often normal to the bed. In this embodiment, the rigid, substantially planar bed 60 is mounted to have a hinge 61 along its front edge and a jack 62 in the form of a threaded thumb screw located on its rear edge. Adjustment of the screw tilts the bed so that the angle of incidence A_{I} of the cutting laser beam 63 with respect to the bed 60 is adjusted to between 0 degrees and about 12 degrees. This results in a degree of freedom in the pitch direction 65 to facilitate orienting the cutting beam to be normal to the surface of the blank 64.

In an alternate approach shown in FIG. 9, the bed 70 for carrying a plurality of lens blanks 71 can be mounted on a gimbal 72 to allow for a further degree of freedom in the roll direction 73 as well as the pitch direction 74.

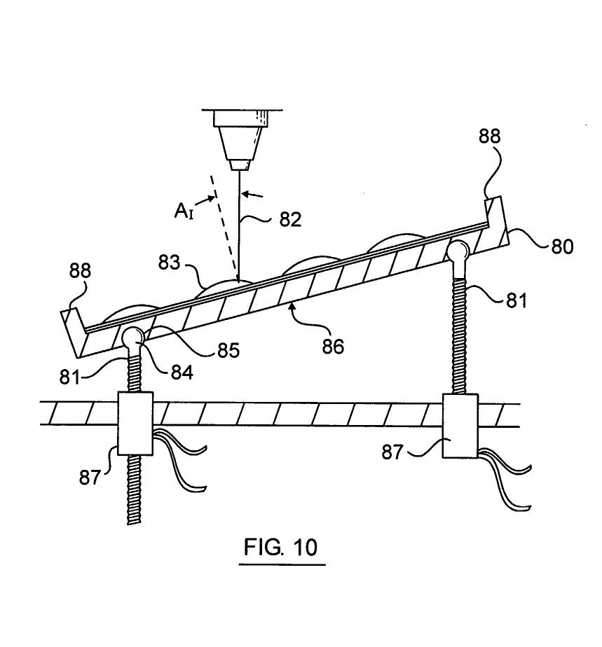

In an alternate embodiment shown in FIG. 10, the bed 80 is mounted upon a number of vertically and separately movable posts 81 wherein the relative vertical movement between posts determines the angle of incidence A_{I} of the laser beam 82 on the blank 83. Using at least three posts separated apart, the vertical positions of the posts can tilt the bed in any angular direction, but within a certain angle of vertical. It has been found that an angle of between 0 and 12 degrees will accommodate most angled drill holes. Bearing between each post and the bed can be in the form of a semi-spherical post tip 84 engaging a semi-spherical depression 85 in the undersurface 86 of the bed. It is also preferable that the height of the post can be adjusted automatically by the microprocessor controlled motors 87. In this embodiment, precise placement of the mat upon the bed is facilitated by at least one alignment prominence in the form of a raised peripheral lip 88.

In the case of lens blanks supported in the convex-side-up orientation, those skilled in the art will readily appreciate that the holes should be cut prior to edging. Further, those skilled in the art will recognize that the carriage for carrying the cutting tool can be made to allow an amount of tilt in the cutting beam. For example, the TILT-A-JET brand abrasive jet cutting head, commercially available from Omax Corporation of Kent, Wash. provides for beam tilting.

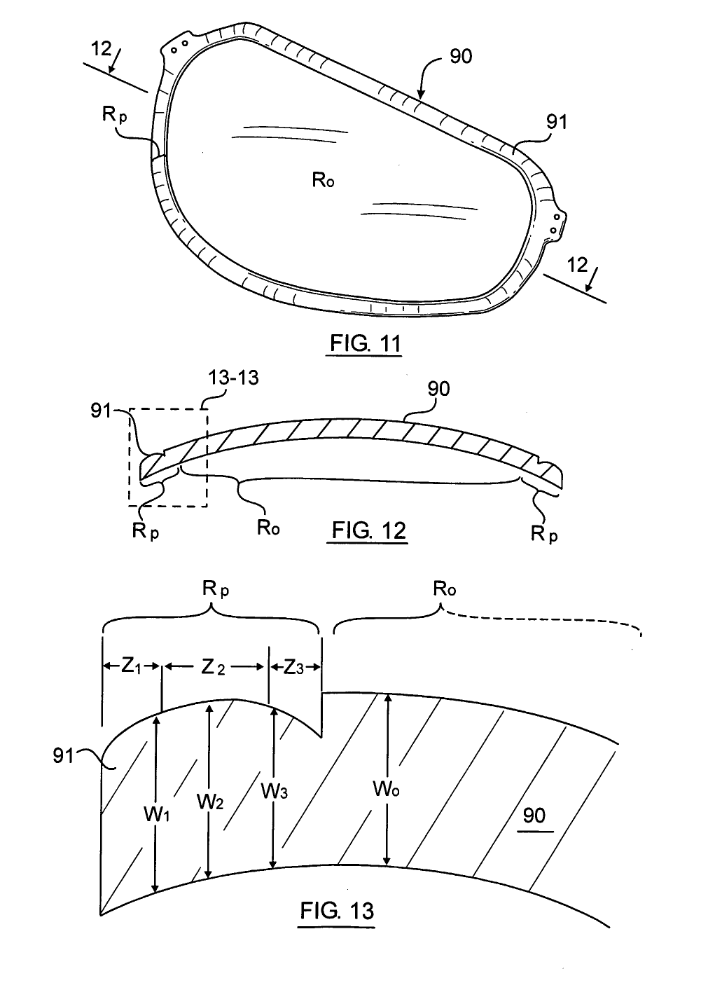

A further embodiment of the invention is now described in reference to FIGS. 11-13. As previously described, the output power of the laser can be adjusted automatically along with the amount of time the laser remains operating at a given position, and/or the number of times the laser passes over a given position at a given power and velocity. This results in the ability to etch through lens material of a certain thickness or to only etch a trough of selectable depth and width in the lens material. Instead of only cutting a peripheral edge of the lens for mounting within a frame or treating its edge to be beveled to be mounted within a frame or polished for use as a rimless lens, the peripheral region R_{P} of the lens 90 which may wholly or partially surround the optical region R_{O} can be partially cut to varying depths so as to form the appearance of a frame 91 or other decorative edge structures in the same processing run as the edging of the lens from the lens blank. For example, as shown in FIGS. 11-13, a lens blank is cut to have a central optical region R_{O} and a peripheral ornamental region R_{P}. If a mimicked frame ornamentation is desired, a generally convex structure is formed within the peripheral region by more deeply etching that zone Z₃ of the peripheral region adjacent to the optical region. The next more peripherally located zone Z₂ is etched less deeply. The next more peripherally located zone Z₁ is etched again more deeply. This etching contour or profile results in a cross-section in which width goes from a narrow first width W₁, to a broader middle width W₂, and back to a more narrow width W₃ to create a generally upwardly convex structure to mimic a frame. For typical lens blanks, W₁, W₂, and W₃ must be less than the original, uncut width W₀, of the blank.

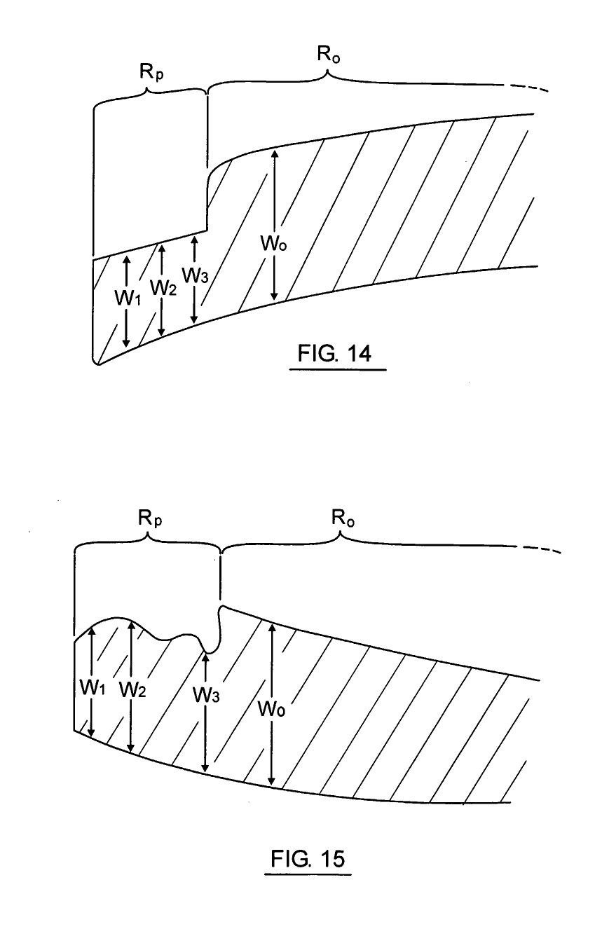

Referring now to FIG. 14, in order to mimic a “wire frame”-type ornamentation structure, the width profile W₁, W₂, and W₃ of the lens 111 is selected to be substantially equal or otherwise linear. The appearance of the “wire-frame” can be further enhanced by selectively tinting, painting or dyeing the ornamentation region R_{P}. It should be noted that the ornamentation region need not be formed around the entire periphery of the lens, but rather can be restricted to a portion of the perphery.

Referring now to FIG. 15, if the ornamentation region is not tinted to be completely opaque, refracted light may undergo chromatic splitting such as in a prism. It has been found that this effect is less desirable when it is seen by the wearer of the eyeglasses, but possibly more desirable when seen by others. Therefore, depending on the shape of the ornamentation, it may be better to form the ornamentation on the concave, inner, or posterior side of the lens. Blanks must then be processed in the concave-side-up orientation.

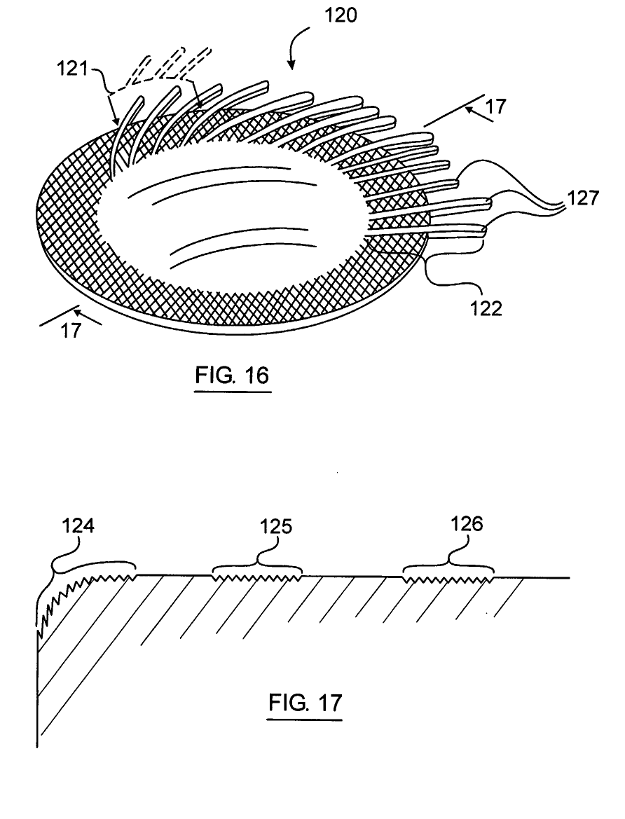

Other ornamental structures can be similarly cut during the same processing run which cuts the lens from the lens blank. For example, as shown in FIG. 16, a design mimicking a stylized anemone 120 can be formed by cutting in a serpentine path 121 a plurality of fingers 127 in the peripheral ornamentation region 122 of the lens. Between the fingers and around the remainder of the peripheral ornamentation region, a cross-radial design pattern of troughs 123 can be etched into the outer surface by partial etching at a lower power.

As shown in FIG. 17, the depth of the partial etching of the lines of the cross-radial design can be varied to create a micro-texturing 124,125,126 on the surface of the lens which is more susceptible to carrying a tint, dye, or paint than the unetched surface or other evenly etched portions. In this way, variable tinting can be accomplished.

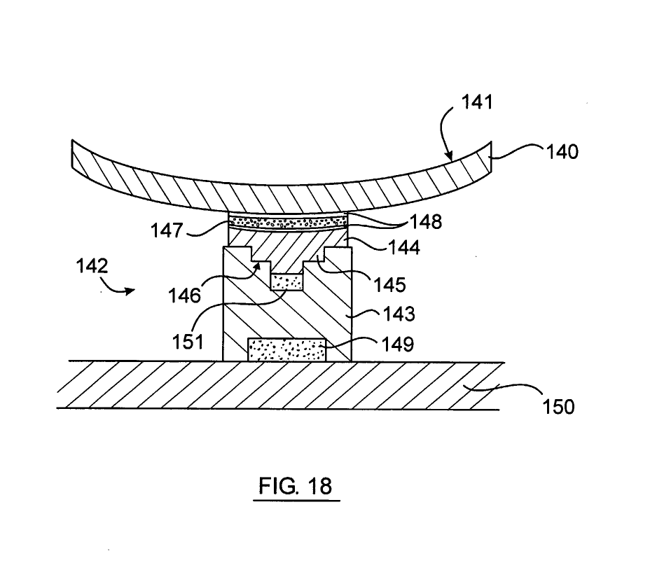

Referring now to FIG. 18, there is shown an alternate embodiment of the device where the holder or bed is adapted to releasably secure each lens blank 140 in a “concave-surface-up” orientation where the inner, posterior, concave surface 141 of the blank faces upward. The lens blank is temporarily mounted to a blocking structure 142 having a generally cylindrical body 143 and an arcuate cup portion 144 often referred to as the “block” fastened to the top. The bottom surface of the cup portion is preferably shaped to have a keyed prominence 145 which engages a correspondingly shaped depression 146 in the top of the body in a specified angular orientation. A magnet 151 located adjacent to and below the depression releasably secures the ferro-magnetic material cup portion to the body.

The use of an angularly keyed interlocking structure between the cup portion and the body allows the lens blank to be optically “blocked” or just merely held in place by the blocking structure. If the blank is optically “blocked”, some of the lens blank parameters can be ignored. If the blank is not optically blocked, the lens will be cut similarly to the previous embodiment. Regardless of whether the blank is blocked, those skilled in the art will appreciate that the blank must still be precisely located so that the cutter cuts at the desired location. The cup supports an arcuate leap pad 147 made of resilient material such as foam rubber. The top and bottom surfaces of the pad have sticky layers 148 for contacting the blank and cup, and securing them against unwanted relative movement. The blocking structure is releasably bonded to the bed 150 by means of a magnet 149 located at the bottom end of the body where the bed is made at least partially from a ferro-magnetic material.

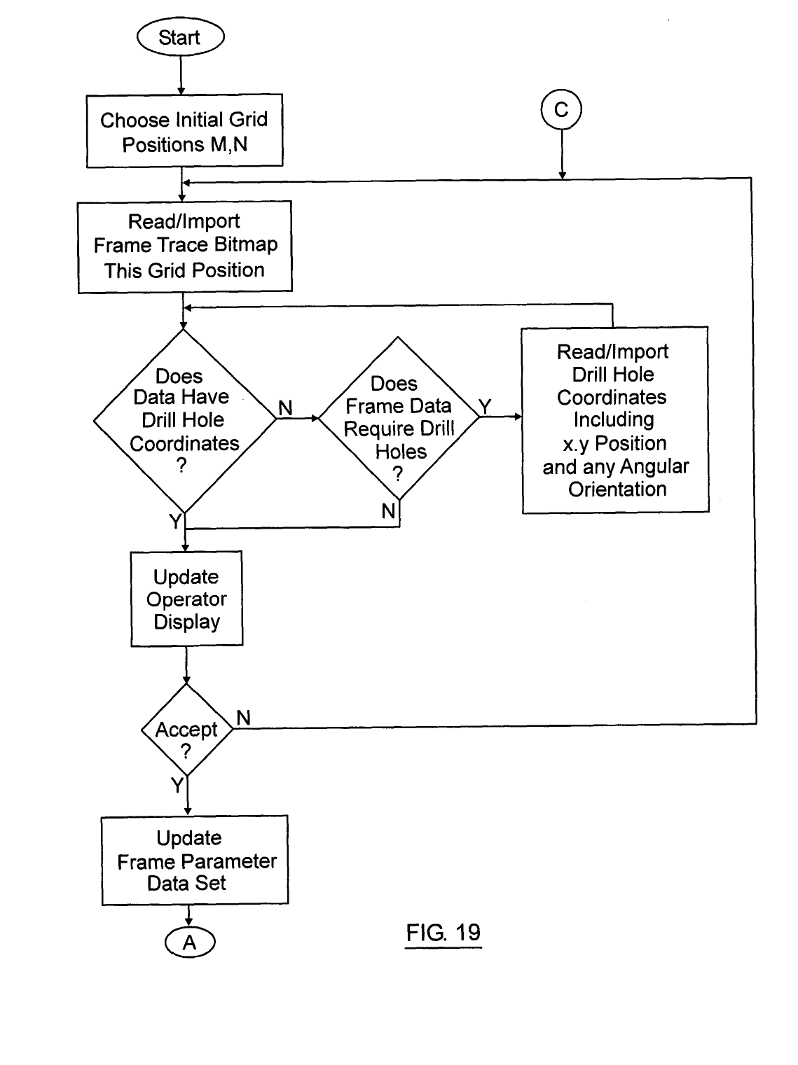

Referring now to FIGS. 19-21, the generalized functional process of the software system for guiding the beam-type cutter will be described. The software system comprises routines which generally prepare the data sets necessary to direct the cutter along a path for each blank in a processing run. The routines generally access the data sets from a database or from other inputs including, for example, a separate tracer for the frame parameters, and/or the operator. The routines also allow for the operator to make changes or enter parameters which may not have otherwise been entered including etching depth data or texturing data. The system then calculates the vectorized cutting path from the accepted parameter data sets which can include power settings, velocity, and pitch and roll data of the cutter with respect to the blank holder. The system serially addresses the data sets for each grid position in the holder because each position can cut a completely different lens. However, those skilled in the art will appreciate that the routines can be easily adapted to more efficiently account for the situation where there is a single run containing identical information across a number of grid positions.

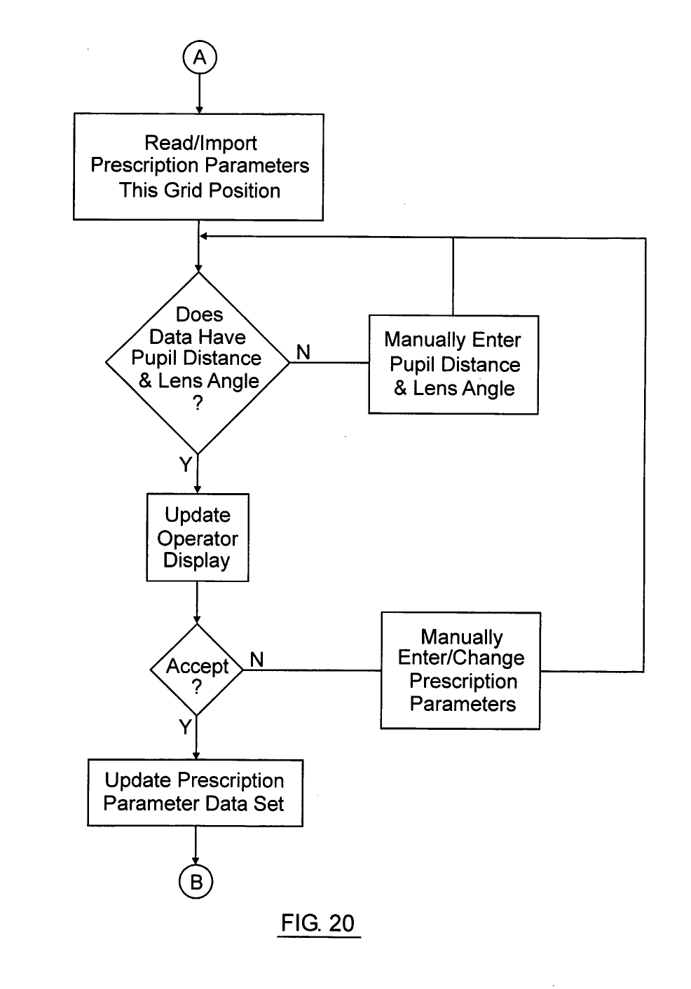

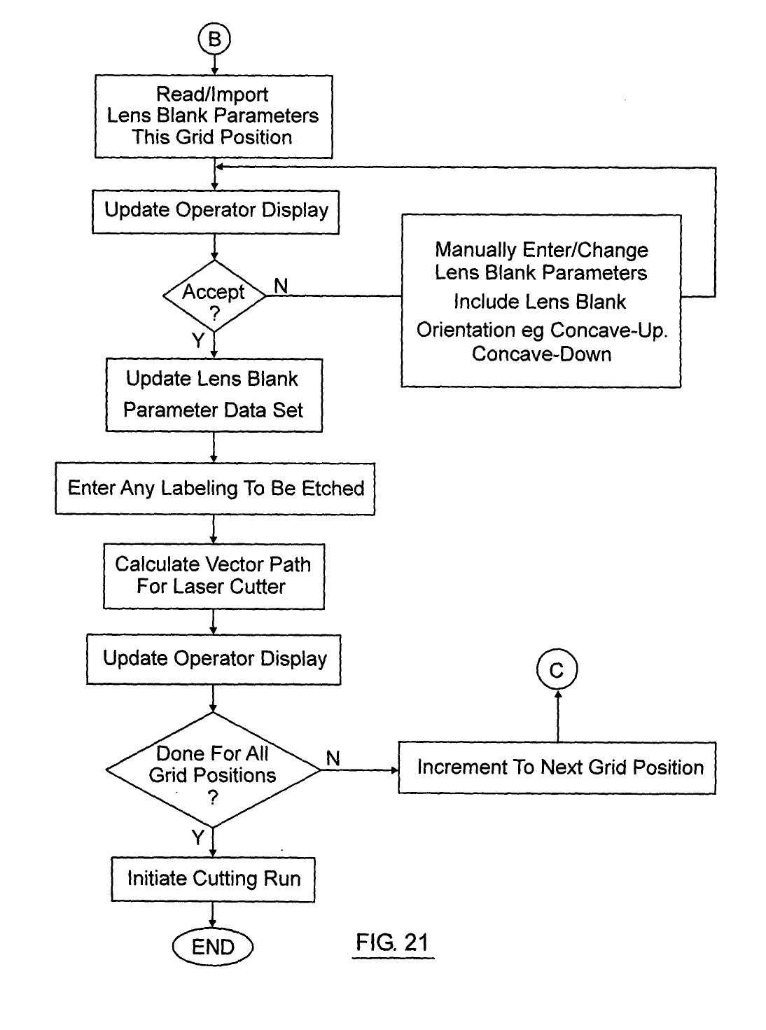

As shown in FIG. 19, because some tracing equipment will not detect the location and orientation of any required through-holes, the operator is queried to supply these parameters. Because the frame data set can be primarily filled by the output of an automated tracer, the system is capable of handling new frame designs without reprogramming. As shown in FIG. 20, the most important prescription parameters of the wearer's pupil distance and lens angle are especially queried. As shown in FIG. 21, the lens blank parameter data set includes a blank orientation parameter for tracking whether the blank will be etched in the “convex-side-up” or “concave-side-up” orientation. Because of the high precision capable of currently available fluid jet or laser engravers, the lens edging device can be further adapted to engrave a label or other writing on the lenses. Once the parameters are input, the system calculates the vectorized path for the cutter and displays it to the operator for final approval before initiating the process run.

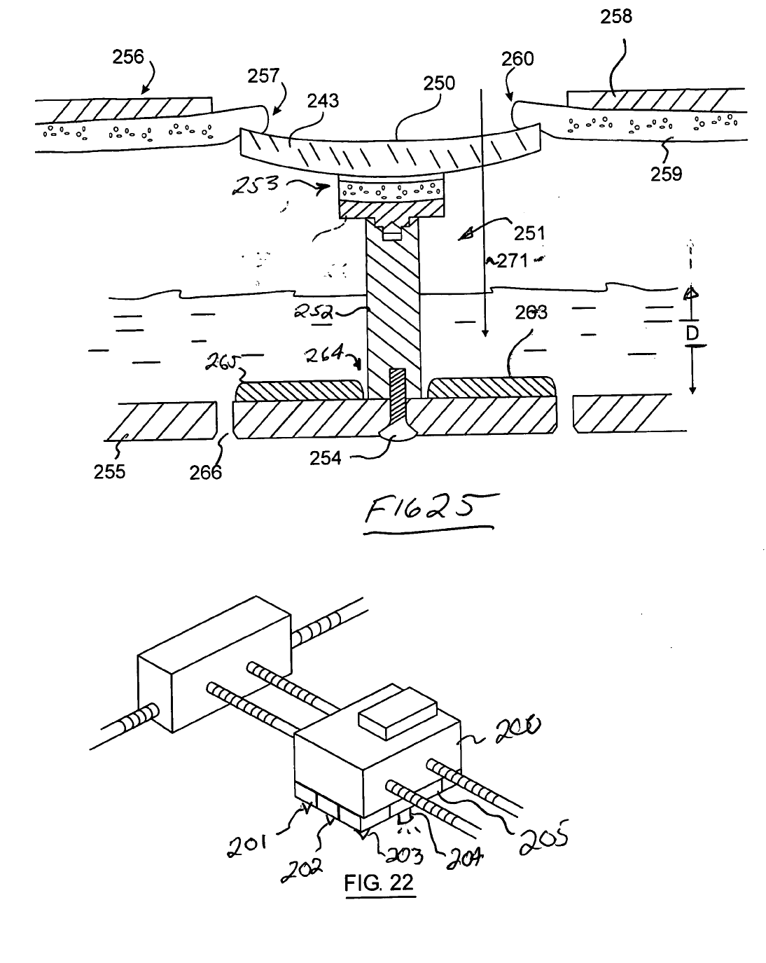

Ornamentation can often include the selective use of color on the lens and ornamentation structures. As shown in FIG. 22, the carriage 200 for translating the cutter can be further adapted to carry in addition to the cutter 201, an ink or dye dispenser 202 for precisely spraying or otherwise dispensing ink, dye or other coloring substance upon some or all of the surfaces of the lens. Since many inks are UV curable, the carriage carrying the cutting tool can be adapted to carry a UV curing lamp 203, or air dryer nozzle 204, or other devices. Since many lenses are made from material which may not carry inking for an extended time, the lens surface many benefit from being pretreated to enhance the adhesion or permanence of the coloring. One method is to provide an additional dispensing tool 205 for precisely depositing an amount of lacquer or other substance which better adheres to the lens material and which, when dry, can carry ink. The carriage can be adapted to carry such an additional dispenser and other devices such as heating lamps to speed drying of the lacquer. Multiple inking steps can be made with or without curing so as to provide colored regions having a different permanence. For example, the frame portions of the lens can be pretreated through microtexturing to carry a more permanent coloring and the ink cured. Later, an additional coloring step on a non-pretreated portion of the lens or without curing can be made to create a coloring region which will wear or wash off in a relatively short time. These short term colored regions can include pricing information, instructions to the user, optical center dots and the like.

The laser cutter can also be adapted to act as a welding tool for attaching bridge and temple pieces using a laser based fusing process as disclosed in U.S. Pat. No. 6,752,893 incorporated herein by this reference. As more active heads are placed on the carriage, there may be a need to protect one or more of the heads during operation of another head. For example, during operation of an abrasive jet there may be splatter occurring which could interfere with the operation of a UV lamp. In this case a moveable guard can be placed over the head or nozzle to be protected during operation of a different head.

Referring now to FIG. 23, there is shown an alternate embodiment of a lens blank holder 230 particularly adapted to manipulation by automated equipment such as through a robotic manipulator arm 231 and conveyor system 232 carrying a plurality of such holders 233. Processing of the lens blanks is made through use of a plurality of processing stations 235,236, 237 including an abrasive water jet cutting station 235 for edging a lens from a blank, a color pretreatment station 236 for pretreating the lens such as through microtexturing to better accept coloring, and a coloring station 237 for dispensing colorizing tints or inks. The operation of the stations is preferably controlled by a single microprocessor based controller 238 running routines such as those described above.

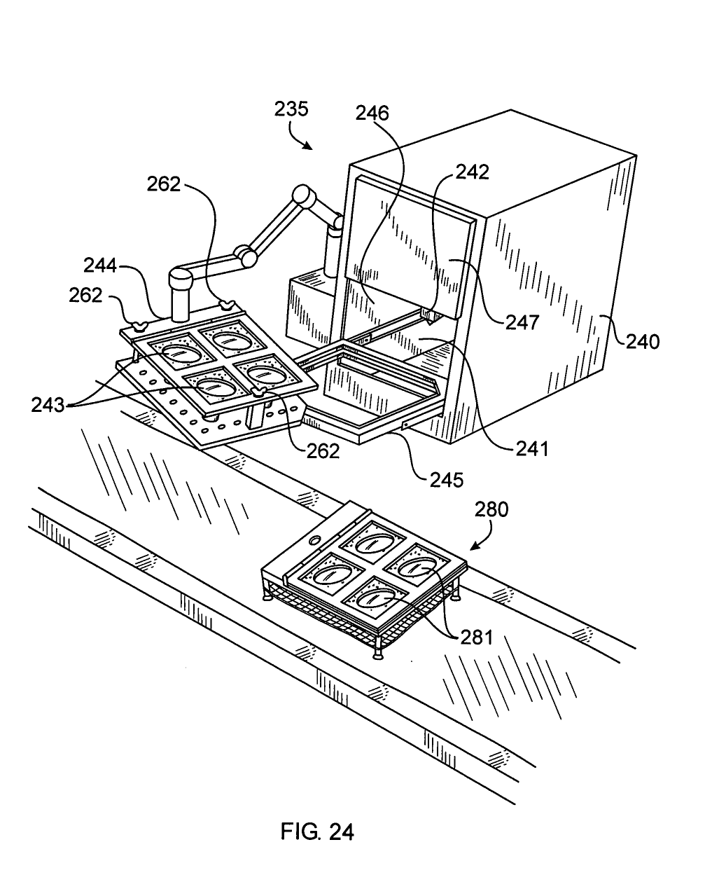

Referring now to FIG. 24, there is shown the abrasive water jet cutting station 235 having a housing 240 having a horizontally translatable abrasive water jet cutting tool 241 mounted upon an XY movable carriage 242 and oriented to emit a cutting beam for edging a plurality of lens blanks 243 temporarily secured within a holder or bed 244 adapted to be precisely and removably secured upon slidingly mounted to a drawer mechanism 245 for extraction from the internal cavity 246 of the station housing 240 through an opening which is closed by a sliding door 247 during operation. The cutting station can be adapted from existing abrasive water jet machining devices such as 1-2400 IFB brand cutting system, commercially available from Flow International Corporation of Kent, Wash.

Referring now to FIGS. 24-25, the holder releasably secures a number of lens blanks 243 in a “concave-surface-up” orientation where the inner, posterior, concave surface 250 of the blank faces upward. The lens blank is temporarily mounted to a blocking structure 251 similar to that disclosed in connection with the embodiment of FIG. 18 having a generally cylindrical body 252 and an arcuate cup portion 253 for contacting the convex surface of the blank. A screw-type fastener 254 releasably secures the blocking structure to a baseplate 255 of the holder. The holder has an apertured cover 256 for contacting the blanks on their concave side peripheral edges 257 to further secure the positioning of the blanks against the potentially rigorous abrasive water jet cutting process. The cover has an upper framework 258 made from a rigid durable material such as stainless steel bonded to a lower framework 259 made from an apertured sheet of durable resiliently flexible material such as a neoprene rubber. The apertures 260 through the framework are shaped and dimensioned to contact the periphery of the lens blank. For most blanks the apertures are thus substantially cylindrical and have a diameter slightly smaller than that of the lens blank. The diameter is preferably selected to create an overlap of at least 3 millimeters. In order to accommodate lens blanks of varying thicknesses, the cover should be both hingedly and height adjustably mounted to the holder as shown by the hinge 261 and height adjustment screws 262.

Because the beam from an abrasive water jet cutting tool can be damaging to any structures it contacts, and because the cutting strength of the beam decreases as the distance from the tool nozzle increases, an axial length L of the body 252 is selected allow the strength of the beam to reduce before it contacts the baseplate 255. For most single lens blank cutting applications that distance is preferably at least 3 centimeters. That distance can be reduced if other structures are provided dissipate the beam after it has passed through the blank. One option is to provide a protective bib 263 of inexpensive disposable material such as a disk of polyvinyl plastic. The disk is shaped and dimensioned to surround the base of the cylindrical body 252 and thus has a central hole 264. The periphery 265 of the bib can be selected to not extend over drainage holes 266 in the baseplate 255.

Alternately, or in addition to the bib, a depth D of fluid can be allowed to pool between the blank 243 and the baseplate 255. Further, the fluid can be made to have a current, indicated by flow arrows 270, flowing in a direction substantially perpendicular to the direction of the cutting beam 271. The presence of the depth of fluid greatly reduces the beam strength by the time it reaches the baseplate.

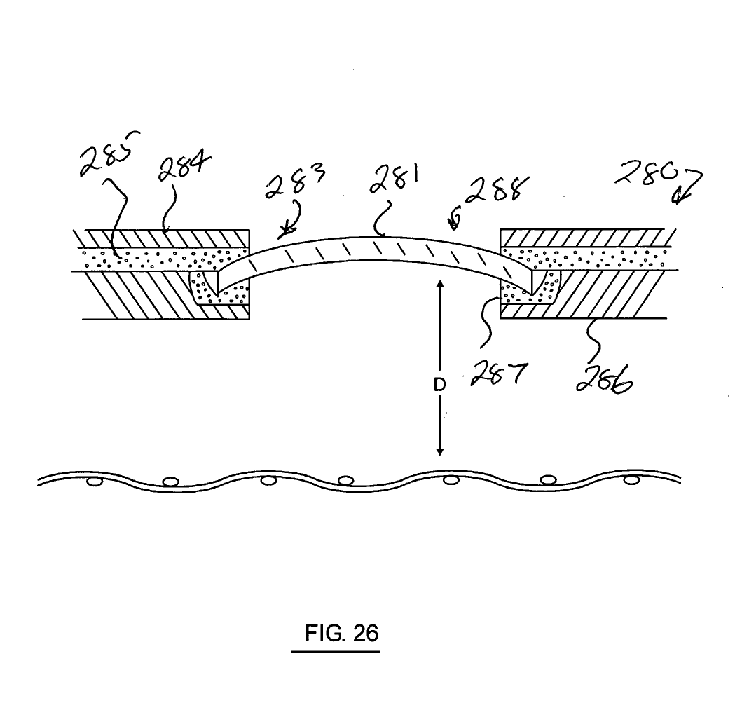

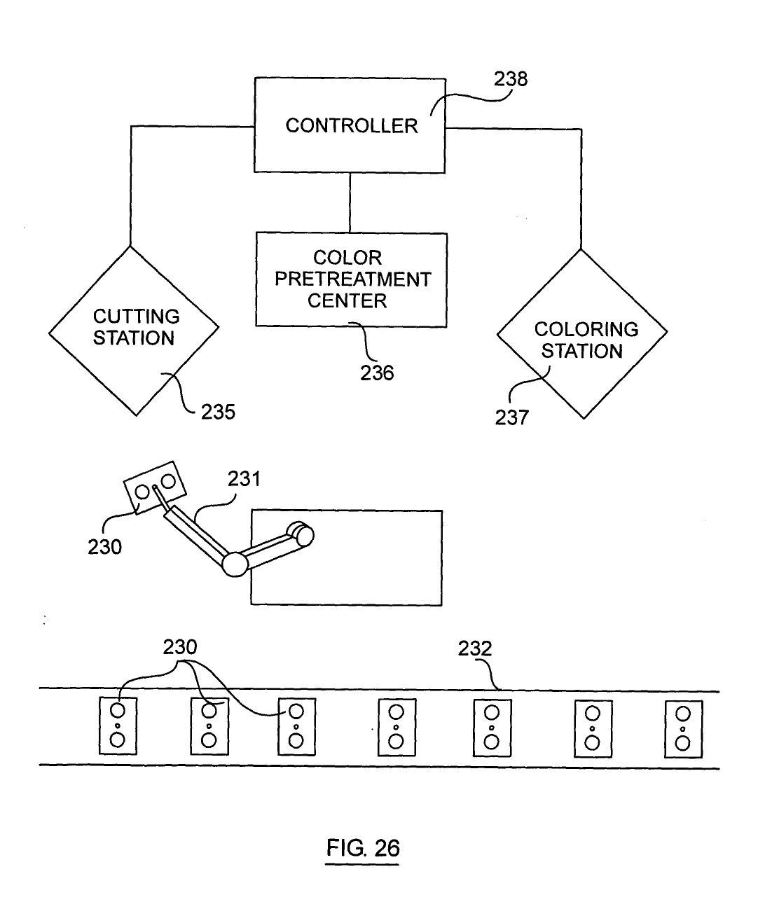

Referring now to FIGS. 24 and 26, there is shown a holder 280 which releasably secures a number of lens blanks 281 in either a “convex-surface-up” or “concave-surface-up” orientation. Each lens blank is temporarily secured within a sandwiching structure 282 having an apertured cover 283 similar to the embodiment of FIG. 25 having an upper rigid framework 284 bonded to a lower resiliently flexible framework 285, and an apertured baseplate having a lower rigid framework 286 and an upper resiliently flexible framework 287. The apertures 288 through the frameworks are shaped and dimensioned to contact the periphery of the lens blank. For most blanks the apertures are thus substantially cylindrical and have a diameter slightly smaller than that of the lens blank. The diameter is preferably selected to create an overlap of at least 3 millimeters. Similarly, for lens blank size flexibility, the cover should be both hingedly and height adjustably mounted to the holder.

Referring back to FIG. 23, the coloring pretreatment station 236 has a laser engraving tool mounted upon an XY movable carriage and oriented to emit a beam upon a lens blank surface to prepare it for accepting coloring. The station can be adapted from a laser-based cutting station described above.

The coloring station 237 has a horizontally translatable ink dispensing tool mounted upon an XY movable carriage and oriented to emit an ink jet upon a lens blank surface to color it. The coloring station can be adapted from existing color inkjet printing devices such as the MERLIN FG brand ink printing system, commercially available from Spectra, Inc. of Lebanon, N.H.

It should be understood that the holders and color pretreatment and coloring stations can be adapted to manually color existing framed eyeglasses such as prescription eyeglasses or non-prescription sunglass type eyeglasses. The holder 24 of FIG. 4 can be readily adapted to temporarily carry a pair of framed eyeglasses securely for coloring. An amount of hand formable material such as modeling clay can be used to properly orient the eyeglasses. Alternately, a pair of blocking structures can be used which may require temporary removal of the temple pieces if supported convex-side-up. In this way, framed eyeglasses can be custom colored according to the particular wishes of an end user.

It should be noted that the processing stations can be adapted to carry detectors for augmenting the data sets during processing. For example, the cutting station can be adapted to carry an optical detector for detecting lens blank parameters such as lens blank orientation or even the optical center and optical axis locations.

While the preferred embodiment of the invention has been described, modifications can be, made and other embodiments may be devised without departing from the spirit of the invention and the scope of the appended claims.

1. A device for forming a plurality of eyeglass lenses in a single automated processing run from a plurality of lens blanks, said device comprises:
a holder sized and shaped to carry said blanks;
a cutter tool; and,
a microprocessor adapted to control a location of said cutting tool with respect to said holder according to a frame parameters data set, a lens blank parameters data set and a prescription parameters data set.

2. The device of claim 1, wherein said frame parameters data set comprises data representing a plurality of frame shapes.

3. The device of claim 1, wherein said lens blank parameters data set comprises data representing a plurality of lens blank types.

4. The device of claim 3, wherein said prescription parameters data set comprises data representing a plurality of prescriptions.

5. The device of claim 1, wherein said lens blanks parameters data set comprises lens blank parameters for each of said blanks.

6. The device of claim 1, wherein said frames parameters data set comprises an ornamental structure definition section.

7. The device of claim 1, wherein an angle of incidence between said cutter tool and said holder is adjustable.

8. The device of claim 1, wherein said device further comprises a blocking structure for each of said blanks.

9. The device of claim 8, wherein said blocking structure comprises:
a rigid body;
an arcuate pad portion adapted to contact a lens blank surface; and
means for temporarily bonding said blocking structure to one of said holding portions.

10. The device of claim 9, wherein said blocking structure further comprises magnetic means for temporarily securing said pad portion to said body.

11. The device of claim 1, wherein said microprocessor is further adapted to control an operational strength of said cutter to control a cutting depth of said cutter.

12. The device of claim 1, wherein said cutter is selected from the group consisting of laser cutters, water jet cutters, and abrasive water jet cutters.

13. The device of claim 1, wherein said device further comprises each of said blanks being marked with an angular orientation indicia.

14. The device of claim 1, wherein said device further comprises means for cutting nose-bridge and temple attachment through-holes in said blanks.

15. A method for forming an eyeglass lens from a lens blank, said method comprises:
placing said blank into a holder;
accessing a frame parameter data set, and a lens blank parameter data set;
calculating a cutting path from said data sets; and,
edging said blank according to said path using a cutting beam.

16. The method of claim 15, which further comprises:
determining an optical angular orientation parameter of said blank;
wherein said placing occurs according to said orientation parameter; and,
wherein said accessing comprises accessing a prescription data set.

17. The method of claim 15, which further comprises drilling nosebridge and earpiece attachment holes prior to said edging step.

18. The method of claim 17, wherein said cutting path is serpentine.

19. The method of claim 15, wherein said edging comprises forming a frame structure from said blank.

20. The method of claim 15, which further comprises dispensing an amount of ink onto a surface of said blank to create a colored region.

21. The method of claim 15, which further comprises pretreating a surface of said blank with a coloring pretreatment to enhance a permanence of said colored region.

22. The method of claim 15, wherein said etching comprises forming a microtextured surface from said blank, and coloring said microtextured surface.

23. The device of claim 1, wherein said device further comprises an ink dispensing tool.

24. The device of claim 23, wherein said microprocessor is further adapted to control a location of said ink dispensing tool.

25. The device of claim 1, wherein said cutter tool is mounted within a first cutting station and said ink dispensing tool is mounted within a second inking station.

26. The device of claim 25, wherein said device further comprises a mechanism for moving said holder between said first and second stations.
